(19) United States
(12) Patent Application Publication
(10) Pub. No.: US 2008/0030469 A1
(43) Pub. Date: Feb. 7, 2008

(54) WIRELESS MOUSE

(75) Inventors: Hong-Che Yen, Taipei (TW); Chih-Hung Lin, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 11/470,725

(22) Filed: Sep. 7, 2006

(30) Foreign Application Priority Data
Aug. 4, 2006 (TW) 095128596

(51) Int. Cl. G09G 5/08

(52) U.S. Cl. 345/163

(57) ABSTRACT

A wireless mouse includes a housing, a rubbery cover and a wireless signal receiver. The housing has a receptacle therein for accommodating the wireless signal receiver therein. The receptacle has an entrance exposed from the housing. The rubbery cover can be plugged into the entrance of the receptacle to close the receptacle.

### FIELD OF THE INVENTION

The present invention relates to a wireless mouse, and more particularly to a wireless mouse capable of storing a wireless signal receiver within a main body thereof.

### BACKGROUND OF THE INVENTION

Nowadays, mice become essential input devices of computer systems. As known, when the wired mouse is used, the wire linkage is very troublesome and inconvenient because an additional signal wire is employed to connect the computer with the mouse. In comparison with the wired peripheral technology, the wireless mouse is more user-friendly. With increasing development of the wireless communication technologies, wireless mice have experienced great growth and are rapidly gaining in popularity. Instead of using the signal wire, when the wireless mouse is operated, a corresponding wireless signal receiver is used for receiving the wireless signal issued from the wireless mouse. The wireless signal receiver is connected to the universal serial bus (USB) port of the host computer, and thus the signals generated from the wireless mouse can be transmitted to the host computer via the wireless signal receiver. Although this wireless mouse is convenient because no signal wire is required, this wireless mouse still has several drawbacks. For example, if the wireless mouse and the wireless signal receiver are separately stored, the probability of losing either the wireless mouse or the wireless signal receiver is increased. For storing the wireless signal receiver within the main body of the wireless mouse, a wireless mouse having a foldable cover was designed.

Referring to FIG. 1, a schematic exploded view of a conventional wireless mouse having a foldable cover is illustrated. The wireless mouse 1 of FIG. 1 includes an upper housing 10A, a lower housing 10B, a foldable cover 11 and a wireless signal receiver 12. A receptacle 13 is defined between the upper housing 10A and the lower housing 10B. The foldable cover 11 is disposed outside the receptacle 13. After the wireless signal receiver 12 is accommodated within the receptacle 13, the foldable cover 11 is closed to prevent detachment of the wireless signal receiver 12 from the wireless mouse 1.

Please refer to FIG. 1 again. In the wireless mouse of FIG. 1, the foldable cover 11 has a connecting part 111, which is substantially a hollow post. After a retaining shaft 14 is penetrated through the connecting part 111, both ends of the retaining shaft 14 will be inserted into retaining holes (not shown) in the lower housing 10B. Consequently, the foldable cover 11 is pivotally coupled to the lower housing 10B. In a case that the foldable cover 11 is opened, the wireless signal receiver 12 can be inserted into the receptacle 13. In contrast, the foldable cover 11 is closed to prevent detachment of the wireless signal receiver 12 from the wireless mouse 1.

As also shown in FIG. 1, the foldable cover 11 and the upper housing 10A further comprise a first engaging element 112 and a second engaging element 15, respectively. The second engaging element 15 is coupled to a resilient element 16 and a click button 17. In response to a pushing force applied on the click button 17, the first engaging element 112 is disengaged from the second engaging element 15 such that the foldable cover 11 is opened. Whereas, when the foldable cover 11 closed, the first engaging element 112 is engaged with the second engaging element 15 due to the restoring force generated from the resilient element 16.

Since the foldable cover 11 of the wireless mouse 1 is made of hard material, the pivotal elements such as the connecting part 111 and the retaining shaft 14 are required to permit rotation of the foldable cover 11. In addition, the locking elements such as the first engaging element 112 and the second engaging element 15 are needed to close and fix the foldable cover 11. Since too many components are added, the wireless mouse is not cost-effective and the assembling tolerance thereof is increased.

In views of the above-described disadvantages resulted from the prior art, the applicant keeps on carving unflaggingly to develop a wireless mouse according to the present invention through wholehearted experience and research.

### SUMMARY OF THE INVENTION

It is an object of the present invention to provide a wireless mouse having a receptacle for storing a wireless signal receiver therein, in which the receptacle is closed by a rubbery cover.

In accordance with an aspect of the present invention, there is provided a wireless mouse. The wireless mouse comprises a housing and a rubbery cover. The housing has a receptacle therein, and the receptacle has an entrance exposed from the housing. The rubbery cover selectively closes the receptacle when the rubbery cover is plugged into the entrance of the receptacle or exposes the receptacle when the rubbery cover is pulled open.

In an embodiment, the rubbery cover further comprises at least a post and an indentation. The post is extended from a surface facing to the entrance, and the tip portion of the post is formed as a bulge. The indentation has a width smaller than the bulge and is formed in the bottom surface of the receptacle corresponding to the bulge, wherein the bulge is embedded into the indentation to prevent detachment of the rubbery cover from the housing when the rubbery cover is plugged into the entrance of the receptacle.

In an embodiment, the housing further comprises a recess structure proximate the entrance of the receptacle. A portion of the rubbery cover is exposed to the recess structure when the rubbery cover is plugged into the entrance of the receptacle.

In an embodiment, the wireless mouse further comprises a wireless signal receiver to be accommodated within the receptacle.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view of a conventional wireless mouse having a foldable cover; and

FIGS. 2A and 2B are schematic perspective and exploded views of a wireless mouse according to a preferred embodiment of the present invention, respectively.

### DETAILED DESCRIPTION OF THE PREFERRED EMBODIMENT

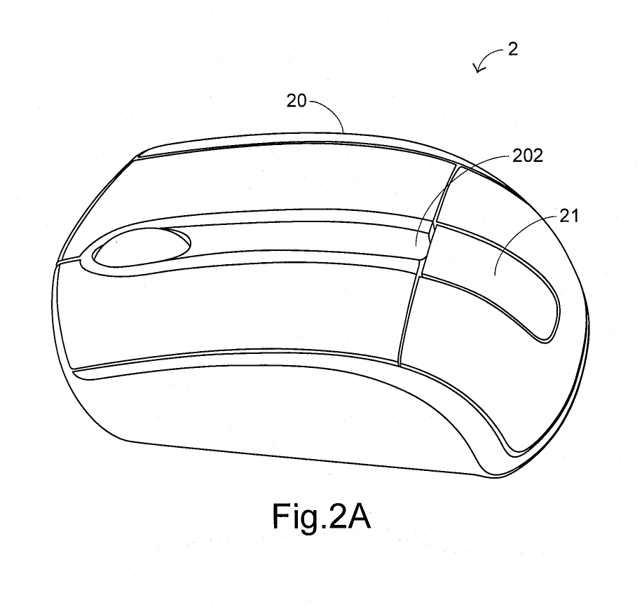

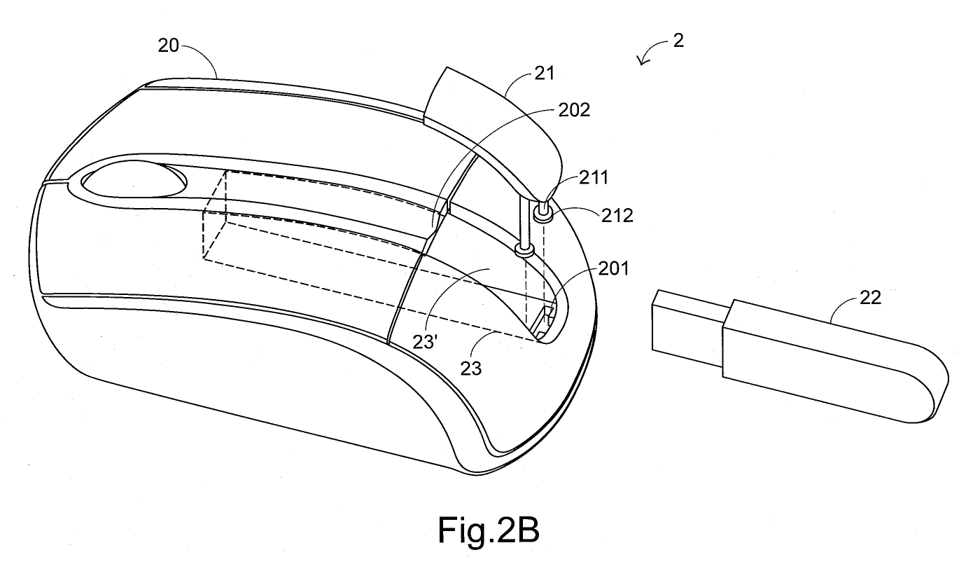

Referring to FIGS. 2A and 2B, schematic perspective and exploded views of a wireless mouse according to a preferred embodiment of the present invention are respectively illustrated.

As shown in FIGS. 2A and 2B, the wireless mouse 2 comprises a housing 20, a rubbery cover 21 and a wireless signal receiver 22. A receptacle 23 is defined within the housing 20 for accommodating the wireless signal receiver 22 therein. The receptacle 23 has an entrance 23′ exposed from the housing 20 for receiving or exiting the wireless signal receiver 22 therein/therefrom. Since the rubbery cover 21 is made of rubbery material, the rubbery cover 21 is flexible. After the wireless signal receiver 22 is accommodated within the receptacle 23, the rubbery cover 21 can be plugged into the entrance 23′ of the receptacle 23 such that the receptacle is closed. Whereas, by simply removing the rubbery cover 21, the wireless signal receiver 22 and the receptacle 23 are exposed from the housing 20. Meanwhile, the user may withdraw the wireless signal receiver 22 from the receptacle 23.

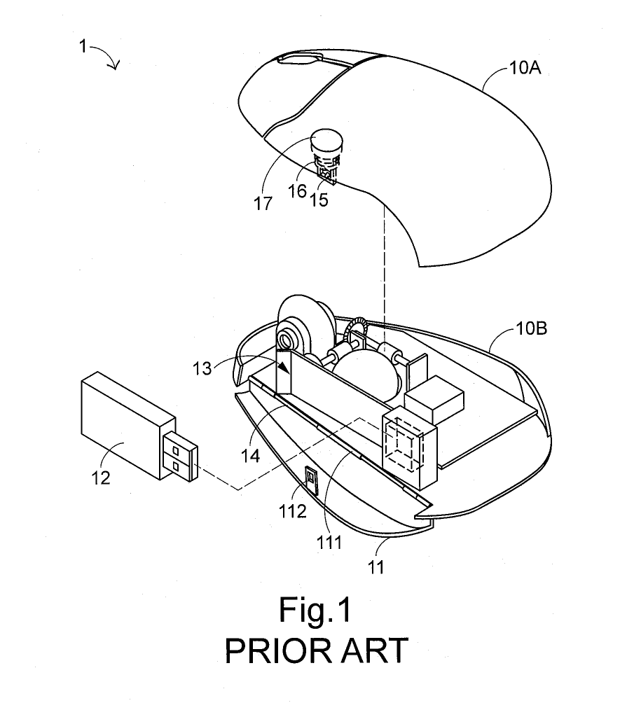

Due to the flexibility of the rubbery cover 21, the rubbery cover 21 is deformed when a pushing force is applied thereon. Under this circumstance, the rubbery cover 21 is easily removed to expose the wireless signal receiver 22. By means of the rubbery cover 21, the conventional pivotal elements such as the connecting part 111 and the retaining shaft 14 shown in FIG. 1 are not required. Moreover, due to the flexibility of the rubbery cover 21, the rubbery cover 21 will be securely attached onto the periphery of the entrance 23′ when plugged into the entrance 23′ of the receptacle 23. In other words, the conventional locking elements such as the first engaging element 112 and the second engaging element 15 shown in FIG. 1 are not indispensable.

Please refer to FIG. 2B again. The rubbery cover 21 further comprises at least a post 211 extended from a surface facing to the entrance 23′. The tip portion of the post 211 is formed as a bulge 212. Corresponding to the bulge 212, an indentation 201 is formed in the bottom surface of the receptacle 23. The width of the indentation 201 is slightly smaller than that of the bulge 212. During the rubbery cover 21 is plugged into the entrance 23′ of the receptacle 23, the bulge 212 is embedded into the indentation 201 to prevent detachment of the rubbery cover 21 from the housing 20.

Please refer to FIGS. 2A and 2B again. The housing 20 further includes a recess structure 202 proximate the entrance 23′ of the receptacle 23. As a consequence, even if the rubbery cover 21 is plugged into the entrance 23′ of the receptacle 23, a portion of the rubbery cover 21 is still exposed to the recess structure 202. By placing a finger into the recess structure 202, the user may easily pull open the rubbery cover 21.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A wireless mouse comprising:
a housing having a receptacle therein, said receptacle having an entrance exposed from said housing;
a rubbery cover selectively closing said receptacle when said rubbery cover is plugged into said entrance of said receptacle or exposing said receptacle when said rubbery cover is pulled open.

2. The wireless mouse according to claim 1 wherein said rubbery cover further comprises:
at least a post extended from a surface facing to said entrance, the tip portion of said post being formed as a bulge;
an indentation having a width smaller than said bulge and formed in the bottom surface of said receptacle corresponding to said bulge, wherein said bulge is embedded into said indentation to prevent detachment of said rubbery cover from said housing when said rubbery cover is plugged into said entrance of said receptacle.

3. The wireless mouse according to claim 1 wherein said housing further comprises a recess structure proximate said entrance of said receptacle, wherein a portion of said rubbery cover is exposed to said recess structure when said rubbery cover is plugged into said entrance of said receptacle.

4. The wireless mouse according to claim 1 further comprising a wireless signal receiver to be accommodated within said receptacle.
